(19) United States
(12) Patent Application Publication
(10) Pub. No.: US 2005/0041008 A1
(43) Pub. Date: Feb. 24, 2005

(54) Electronic system having backlight adjustment function and method of adjusting backlight

(75) Inventor: Yong-Jai Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/899,137

(22) Filed: Jul. 27, 2004

(30) Foreign Application Priority Data
Jul. 28, 2003 (KR) 2003-52058

(51) Int. Cl. G09G 3/36

(52) U.S. Cl. 345/102

(57) ABSTRACT

An electronic system capable of controlling a backlight and a backlight adjustment method thereof. The electronic system comprises a portable display device and a host device, wherein in a state that the portable display device is docked on the host device, the host device transmits to the portable display device an inputted backlight brightness value setting information through a I²C bus, and the portable display device reads-out a pre-stored brightness value data corresponding to the transmitted backlight brightness setting information, and adjusts the backlight lamp based on the read-out brightness value data. Accordingly, since the portable display device can control the brightness value of the backlight lamp, a user's inconvenience caused by a dual control system can be solved.

### CROSS-REFERENCE TO RELATED APPLICATIONS

This application claims the benefit of Korean Patent Application No. 2003-52058, filed on Jul. 28, 2003, in the Korean Intellectual Property Office, the disclosure of which is incorporated herein by reference.

### BACKGROUND OF THE INVENTION

1. Field of the Invention

The present invention relates to an electronic system and a backlight adjusting method thereof, and more particularly, to an electronic system capable of controlling a brightness of a backlight irrespective of docking/undocking of a portable device with respect to a host device through a controller disposed in the portable display device, and a backlight adjusting method thereof.

2. Description of the Related Art

Generally, a personal computer enables a user to perform various information processing works at home, such as web-surfing, e-mailing, and enjoying music and movies. In order to satisfy the user's diversified needs for the information processing works, a portable display device which is disconnected from a host device but is capable of mutual wireless communication with the host device has been developed. Such a portable display device is called a “smart display”. The host device is generally a personal computer, but any device can be used as the host device if the device has an information processing function.

Such a portable display device executes different functions according to whether it is docked on/undocked from the host device. That is, when the portable display device is undocked from the host device, the portable display device operates as a wireless communication device, enabling a user to do various types of information processing such as web-surfing, checking e-mail and listing or watching music and movies from different rooms, such as the living room, kitchen, bed room, etc.

Meanwhile, the portable display device simply performs a display function when it is mounted on a docking station of the host device and docked with the host device.

As described above, the portable display device is operated in two operation modes according to whether it is docked on/undocked from the host device. That is, the portable display device is operated in a monitor mode to perform the display function only, when it is docked on the host device, while the portable display device is operated in a wireless monitor mode to perform a wireless communication and a display function when it is undocked from the host device.

FIG. 1 is a block diagrams showing an interior of a conventional electronic system in which only the parts related to a backlight adjustment are illustrated for the convenience of explanations.

The related art portable display device 10 includes a first input unit 11, an embedded-type controller 12, a first storage unit 13, a switching unit 14, an inverter 15, and a backlight lamp 16.

The first input unit 11 is inputted with user's commands or other necessary data, and a USB connector, a touch panel, and a manipulation panel may be used as the first input unit 11. The touch panel generates/processes a signal in correspondence to a contact result. In a case that a backlight brightness adjustment menu is displayed on a display unit (not shown) in an OSD manner, a user inputs backlight brightness setting information by manipulating the touch panel. The backlight brightness setting information is the information that a user inputs to control the backlight lamp 16 provided in the display unit such as a LCD and accordingly, adjust the brightness of the backlight lamp.

The controller 12 embedded in the portable display device 10 is operated by a power supplied to the portable display device 10, and controls the outputs of RGB signals, vertical synchronization signals, and horizontal synchronization signals which are inputted into buffers (not shown). The controller 12 also controls the outputs of various control signals inputted into switching portions (not shown). The switching unit 14, which is to switch brightness value data of the backlight lamp 16, is controlled by the controller 12. It is general that, when the portable display device 10 is docked on the host device 20, most controllers of the portable display device 10 are usually switched to a non-operational state and are controlled by the host device 20. However, the embedded-type controller 12 maintains its active state even when the portable display device 10 is docked on the host device 20.

The first storage unit 13 is an EEPROM (Electrically Erasable Programmable Read-Only Memory), which enables a user to correct contents stored in the storage unit under the control of the embedded-type controller 12. That is, the first storage unit 13 can be erased and reprogrammed repeatedly through the application of voltage which is higher than normal level. The first storage unit 13 also stores initial condition information and controls set values of the portable display device 10. The brightness value data is also stored in a predetermined area of the first storage unit 13. The brightness value data may be initially set and stored in correspondence to the backlight brightness setting information inputted by the user, or it may be additionally set and stored afterwards.

The first storage unit 13 stores the backlight brightness setting information pre-set by the user. Accordingly, when the portable display device 10 is shifted from a docking state to an undocking state, the backlight is maintained at the same level as that in the previous undocking state because the pre-stored brightness setting information is read from the first storage unit 13 and applied. When the backlight brightness setting information is inputted into the first input unit 11, the embedded-type controller 12 reads-out from the first storage unit 13 the brightness value data corresponding to the inputted backlight brightness setting information.

The switching unit 14 switches the output of the brightness value data according to the operation mode of the portable display device 10 under the control of the embedded-type controller 12. The brightness value data outputted from the switching unit 14 have two different types of paths according to whether the portable display device 10 is docked on/undocked from the host device 20. That is, in the undocking state, the switching unit 14 outputs the brightness value data that is inputted through the embedded-type controller 12. In the docking state, the switching unit 14 outputs the brightness value data that is inputted through a monitor mi-com 22, which will be described later. The outputted brightness value data is inputted into the inverter 15.

The inverter 15 adjusts a level of voltage to be supplied to the backlight lamp 16 based on the inputted brightness value data. For example, it is assumed that the voltage to be supplied to the backlight lamp 16 ranges from 0V to 3V. In this case, if brightness value data corresponding to a minimum level of brightness is inputted, the voltage value is adjusted to 0V, and if brightness value data corresponding to a maximum level of brightness is inputted, the voltage value is adjusted to 3V. That is, when backlight brightness setting information for a high level of brightness is inputted through the first input unit 11, the inverter 15 increases the level of the voltage to be supplied to the backlight lamp 16 and outputs the increased voltage value. When backlight brightness setting information for a low level of brightness is inputted through the first input unit 11, the inverter 15 decreases the level of the voltage to be supplied to the backlight lamp 16 and outputs the decreased voltage.

Meanwhile, the host device includes a second input unit 21, the monitor mi-com 22, and a second storage unit 23.

The second input unit 21 is inputted with user's commands, and exemplified by a manipulation panel in this embodiment. The manipulation panel is provided with keys for manipulating both the host device 20 and the portable display device 10. The keys include a power on/off switching key, a volume adjusting key, a navigation key, a shortcut key, a menu display key, and a backlight brightness value adjusting key.

Since the second storage unit 23 is operated in a similar manner as the first storage unit 13, detailed description thereof will be omitted. The only difference is that the second storage unit 23 stores pre-set brightness value data corresponding to the backlight brightness setting information inputted by the user, so that, when the portable display device 10 is shifted from a undocking to a docking state, the backlight is maintained at the same level as that in the previous docking state because the pre-stored backlight brightness setting information is read from the second storage unit 23 and applied.

The monitor mi-com 22 outputs RGB signals, horizontal synchronization signals, vertical synchronization signals, and various control signals, to control the portable display device 10 when the portable display device 10 is mounted in the docking station (not shown) and operated in the monitor mode. When the backlight brightness setting information is inputted through the backlight brightness adjusting key of the second input unit 21 on the monitor mode of the portable display device 10, the brightness value data corresponding to the inputted backlight brightness setting information is read out from the second storage unit 23 and transferred to the switching unit 14 of the portable display device 10. The transfer of the brightness value data is illustrated by a one point-dotted line in FIG. 1. The transferred brightness value data is switched by the switching unit 14 and outputted to the inverter 15.

Also, the embedded controller 12 and the monitor mi-com 22 each has a I²C module (not shown). Accordingly, the I²C bus connects the embedded-type controller 12 to the first storage unit 13, and connects the monitor mi-com 22 to the second storage unit 23. When the brightness value data are read out from the first and the second storage units 13, 23, the embedded-type controller 12 and the monitor mi-com 22 operate in a master mode, while the first and the second storage units 13, 23 operate in a slave mode. Accordingly, the first and the second storage units 13, 23 are designated with a slave address.

A reference numeral 30 indicates a docking unit. For example, the docking unit is a connection portion between a docking connector (not shown) and a docking station (not shown).

FIG. 2 is a view showing transfer data of the I²C bus used in the related art electronic system. The transfer data of the I²C bus is comprised of a start bit (S) indicating the beginning of the data transfer of the I²C, a slave address, which is information about a target device to be communicated among a plurality of devices connected to one another via the I²C bus, a bit informing of whether to read or write the data (in this embodiment, a read bit (R)), a data byte storing the to-be-communicated data, and a terminating bit indicating the end of the data transfer of the I²C. The transfer data also includes an acknowledgement signal (A) to check whether the data is successfully received. In the undocking state, the first storage unit 13 is designated with the slave address of the transfer data of the I²C transferred from the embedded controller 12. In the docking state, the second storage unit 23 is designated with the slave address of the transfer data of the I²C transferred from the monitor mi-com 22.

FIG. 3 is a flowchart showing a backlight adjusting method performed by the related art electronic system.

When the portable display device 10 is undocked from the docking station (not shown), an auxiliary process unit (not shown) receives information about the undocking state from the docking connector (not shown). The auxiliary process unit determines the undocking state and provides the undocking state information to the embedded-type controller 12. The embedded-type controller 12 controls the overall operations of the portable display device 10 in correspondence to the undocking/docking state. Particularly, the embedded-type controller 12 controls the switching unit 14 in correspondence to the undocking/docking state. (S40). Then, the portable display device 10 is operated in the wireless monitor mode (S50). When a user inputs backlight brightness setting information through the first input unit 11 (S51), the backlight brightness setting information is transmitted to the embedded-type controller 12 (S52). Then, the embedded controller 12 reads out brightness value data from the first storage unit 13 based on the transmitted backlight brightness setting information. At this time, the read-out is accomplished by designating the first storage unit 13 as the salve address of the transfer data of the I²C bus (S53, S54). The read-out brightness value data is inputted to the inverter 15 through the switching unit 14. The inverter 15 adjusts a level of voltage to be supplied to the backlight lamp 16 based on the inputted brightness value data. Then, the backlight lamp 16 is inputted with the adjusted voltage value and operated with a predetermined brightness corresponding to the adjusted voltage value.

Meanwhile, when the portable display device 10 is docked on the docking station (not shown), the auxiliary process unit (not shown) determines the docking state and provides information about the docking state to the embedded-type controller 12. The embedded-type controller 12 controls the switching unit 14 according to the docking state (S40). Then, the portable display device is operated in the monitor mode (S60). When a user inputs backlight brightness setting information through the second input unit 21 (S61), the backlight brightness setting information is transmitted to the monitor mi-com 22 (S62). The monitor mi-com 22 reads out brightness value data from the second storage unit 23 based on the transmitted backlight brightness setting information. The read-out is accomplished by designating the second storage unit 23 as the slave address of the transfer data of the I²C bus (S63, S64). Based on the read-out brightness value, the brightness of the backlight lamp 16 is adjusted (S55).

As described above, the portable display device 10 employs two-separate systems of the storage units for reading out the brightness value data and the controllers for controlling the read-out brightness value data, which are operated differently according to the mode of the portable display device 10, i.e., according to the monitor mode and the wireless monitor mode. If the brightness value data stored in the respective storage units are different, the display device 10 has different backlight brightness value data according to the docking state or undocking state of the portable display device 10. This may cause the user eye-fatigueness. Also, there is inconvenience in that user is required to adjust the backlight brightness value whenever the portable display device 10 is shifted from the docking state to the undocking state or vice versa.

### SUMMARY

The present invention has been developed in order to solve the above problems in the related art. Accordingly, it is an aspect of the present invention to provide an electronic system capable of controlling a backlight lamp by an embedded-type controller of a portable display device, irrespective of whether the portable display device is docked on/undocked from a host device, and a backlight adjustment method thereof.

The above aspect is achieved by providing an electronic system for transceiving information related to a backlight between a portable display device and a host device docked on each other. In a state that the portable display device is docked on the host device, the host device transmits to the portable display device inputted backlight brightness value setting information to adjust a brightness of the backlight lamp, and a portable display device reads-out a pre-stored brightness value data corresponding to the transmitted backlight brightness setting information, and adjusts the backlight lamp based on the read-out brightness value data.

It is preferred that the backlight brightness setting information is transmitted through an I²C bus.

The portable display device comprises a storage unit for storing the brightness value data corresponding to the backlight brightness setting information, and a first controller for causing the brightness value data to be read out from the storage unit corresponding to the transmitted backlight brightness setting information.

The host device comprises an input unit through which the backlight brightness setting information is inputted, and a second controller for causing the inputted backlight brightness setting information to be transmitted to the first controller.

The first controller and the second controller are connected to each other through the I²C bus, and the backlight brightness setting information is transmitted from the second controller to the first controller by designating the first controller with a slave address of a transfer data of the I²C bus.

The above aspect is also achieved by providing a backlight adjustment method of an electronic system, which transceives information related to a backlight lamp between a portable display device and a host device docked on each other. The method comprises the steps of (a) in a state that a backlight brightness setting information is inputted into the host device to adjust a brightness of the backlight lamp, transmitting the backlight brightness setting information from the host device to the portable display device, and (b) by the portable display device, adjusting a brightness of the backlight lamp corresponding to the transmitted backlight brightness setting information.

### BRIEF DESCRIPTION OF THE DRAWINGS

The above aspect and other features of the present invention will be more apparent by describing a preferred embodiment of the present invention with reference to the accompanying drawings, in which:

FIG. 1 is a block diagram showing an interior of a related art electronic system;

FIG. 2 is a view showing the transfer data of the I²C bus used in the electronic system of FIG. 1;

FIG. 3 is a flowchart showing a backlight adjustment method by the related art electronic system;

FIG. 4 is a block diagram showing an interior of an electronic system according to an exemplary embodiment of the present invention; and

FIG. 5 is a flowchart showing a backlight adjustment method by the electronic system according to the preferred embodiment of the present invention.

### DETAILED DESCRIPTION OF THE INVENTION

Hereinafter, a device and a method of adjusting a backlight according to an exemplary embodiment of the present invention will be described in greater detail with reference to the accompanying drawings.

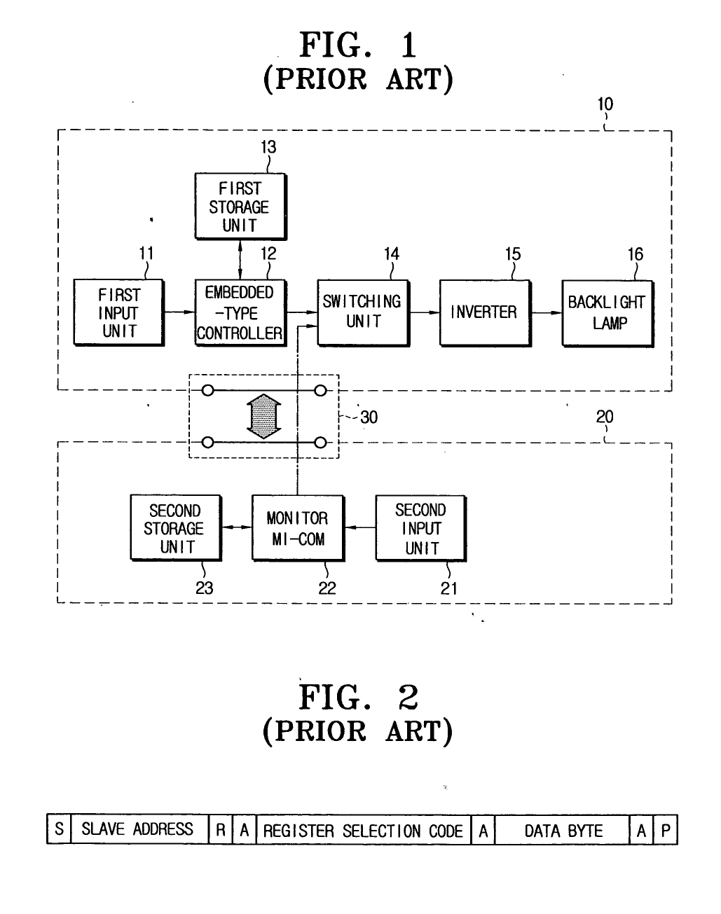

FIG. 4 is a block diagram showing an interior of an electronic system according to the present invention. With respect to the elements identical to those of FIG. 1, detailed descriptions will be omitted.

Referring to FIG. 4, a portable display device 100 includes a first input unit 110, an embedded-type controller 120, a first storage unit 130, an inverter 140, and a backlight lamp 150. A host device 200 includes a second input unit 210, a monitor mi-com 220, and a second storage unit 230. Reference numeral 300 indicates a docking unit.

When the portable display device 100 is docked on the host device 200, the monitor mi-com 220 is connected to the embedded-type controller 120 via an I²C bus. The embedded-type controller 120 is also connected to the first storage unit 130 via an I²C bus.

The monitor mi-com 220 is inputted with backlight brightness setting information from the second input unit 210, and transmits the backlight brightness setting information to the embedded-type controller 120 via the I²C bus connected to the monitor mi-com 220. The data transmission through the I²C bus is performed by designating the embedded controller 120 as a slave address of transfer data of the I²C bus. In FIG. 4, the transmission of the backlight brightness setting information is expressed by a one point-dotted line.

Accordingly, the brightness value data is not stored in the second storage unit 230, and second storage unit 230 can store other types of data instead.

When the backlight brightness setting information is inputted through the first input unit 110 or the monitor mi-com 220, the embedded controller 120 reads out the brightness value data from the first storage unit 130, corresponding to the inputted backlight brightness setting information, and transmits the read-out brightness value data to the inverter 140.

That is, the embedded controller 120 can always control the brightness of the backlight lamp 150, irrespective of whether the backlight brightness setting information is inputted through the first input unit 110 or the second input unit 210.

Also, when the backlight brightness setting information is changed by a user, the first storage unit 130 stores the changed backlight brightness setting information in a predetermined area thereof under the control of the embedded controller 120. The backlight brightness setting information is stored in the first storage unit 130 both in the docking state and the undocking state. Accordingly, the backlight lamp 150 has a constant brightness value irrespective of whether the portable display device 100 is switched from the docking state to the undocking state or from the undocking state to the docking state.

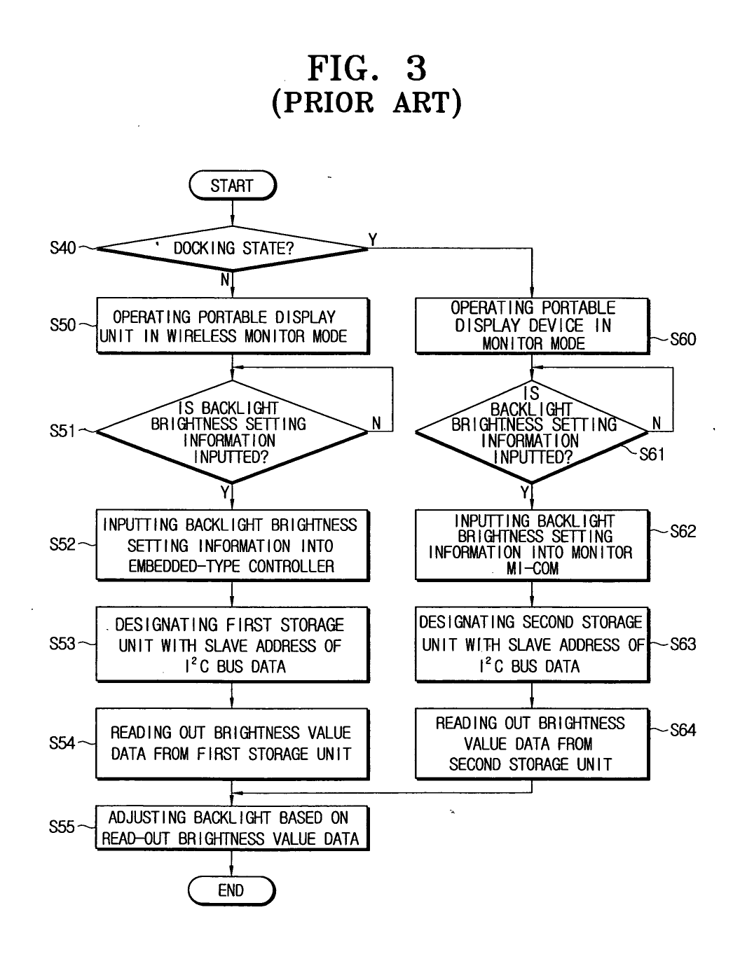

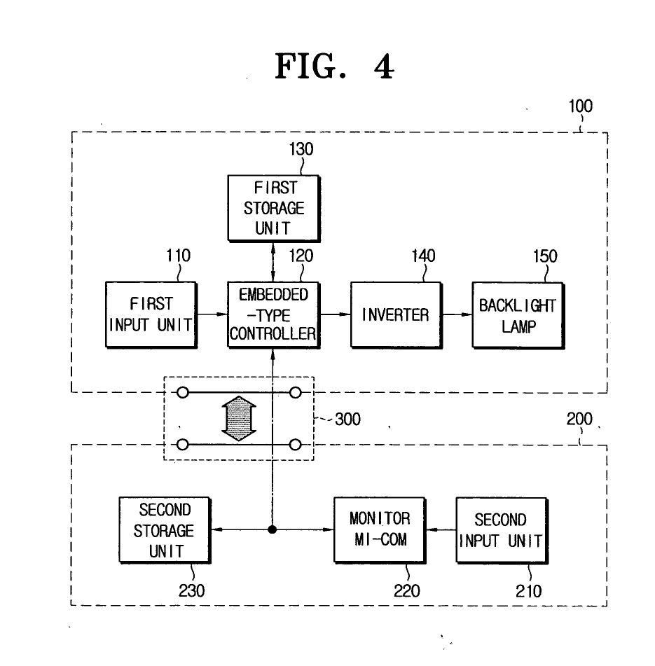

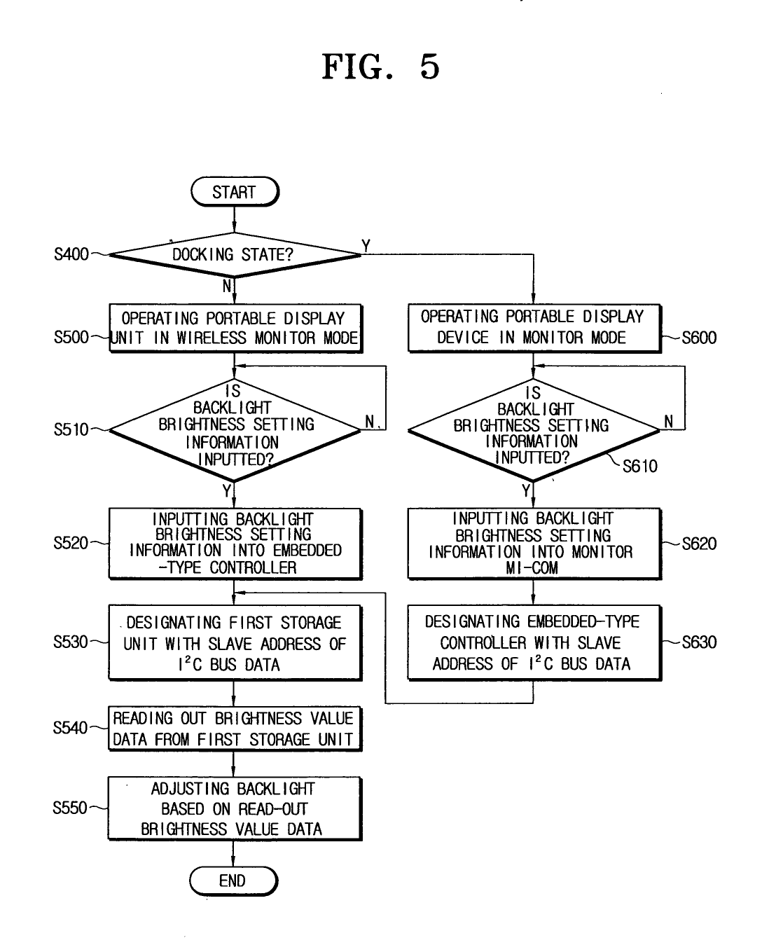

FIG. 5 is a flowchart showing a backlight adjustment method by the electronic system according to the present invention. With respect to the steps identical to those of FIG. 3, detailed descriptions will be omitted.

Since a backlight adjusting process performed when the portable display device 100 is not connected with the host device 200 (from S500 to S550) is identical to that of FIG. 3 (from S50 to S55), description thereof will be omitted.

Rather, since the portable display device 100 of the present invention is differently operated from that of the related art one when the portable display device 100 is docked on the host device 200, it will be described in greater detail hereinbelow.

When the portable display device 100 is docked on the host device 200, an auxiliary process unit (not shown) determines the docking state and provides the information about the docking state to the embedded controller 120. The embedded-type controller 120 processes the overall operations of the portable display device 100 corresponding to the docking state (S400). That is, the portable display device 100 is operated in a monitor mode (S600). In the monitor mode, the first input unit 110 is shifted to an inactive state, while the second input unit 210 is shifted to an active state so that the user inputs the backlight brightness setting information through the second input unit 210 (S610). When the user inputs the backlight brightness setting information through the second input unit 210, the monitor mi-com 220 receives the backlight brightness setting information (S620), and outputs the received information through the I²C bus. At this time, since, instead of the second storage unit 230, the embedded-type controller 120 is designated with a slave address of the transfer data of the I²C bus outputted through the I²C bus (S630), the transfer data of the I²C bus is transmitted to the embedded-type controller 120. Then, the embedded-type controller 120 reads out from the first storage unit 130 the brightness value data corresponding to the backlight brightness setting information existing in the transfer data of the I²C bus. Read out of the data from the first storage unit 130 is accomplished by designating the first storage unit 130 as a slave address of the transfer data of the I²C bus (S530 & S540). The read-out brightness value data is transmitted to the inverter 140. The inverter 140 adjusts a level of voltage to be supplied to the backlight lamp 150 according to the transmitted brightness value data, and provides the adjusted level of the voltage to the backlight lamp 150. Accordingly, a brightness of the backlight lamp 150 is adjusted (S550).

According to the present invention, since the embedded controller 120 of the portable display device 100 can control the brightness value of the backlight lamp 150, a user's inconvenience caused by the related art dual control system can be solved.

Also, since it is not necessary to employ the switching unit, which has to be employed in the related art system, costs are reduced, and therefore, mass-production of the portable display device 100 is enabled.

Also, there is an advantage in that the second storage unit 230 connected to the monitor mi-com 220 can store other types of data since it does not store the backlight brightness value data.

Also, since the information related to the backlight is stored in the same storage unit, the backlight lamp has the constant brightness value both in the docking state and the undocking state.

1. An electronic system for transceiving information related to backlight comprising:
a portable display device; and
a host device;
the portable device and the host device transceiving information related to backlight between the portable display device and the host device when docked on each other,
wherein, in a state that the portable display device is docked on the host device, the host device transmits to the portable display device an inputted backlight brightness value setting information to adjust a brightness of a backlight lamp, and the portable display device reads-out a pre-stored brightness value data corresponding to the transmitted backlight brightness setting information, and adjusts the backlight lamp based on the read-out brightness value data.

2. The electronic system of claim 1, wherein the backlight brightness setting information is transmitted through an I²C bus.

3. The electronic system of claim 2, wherein the portable display device comprises:
a storage unit for storing the brightness value data corresponding to the backlight brightness setting information; and
a first controller for causing the brightness value data to be read out from the storage unit corresponding to the transmitted backlight brightness setting information.

4. The electronic system of claim 3, wherein the host device comprises:
an input unit through which the backlight brightness setting information is inputted; and
a second controller for causing the inputted backlight brightness setting information to be transmitted to the first controller.

5. The electronic system of claim 4, wherein the first controller and the second controller are connected to each other through the I²C bus, and the backlight brightness setting information is transmitted from the second controller to the first controller by designating the first controller with a slave address of a transfer data of the I²C bus.

6. A backlight adjustment method of an electronic system, which transceives information related to a backlight lamp between a portable display device and a host device docked on each other, the method comprising:
(a) in a state that a backlight brightness setting information is inputted into the host device to adjust a brightness of the backlight lamp, transmitting the backlight brightness setting information from the host device to the portable display device; and
(b) by the portable display device, adjusting a brightness of the backlight lamp corresponding to the transmitted backlight brightness setting information.

7. The backlight adjustment method of claim 6, wherein the backlight brightness setting information is transmitted through an I²C bus.

8. The backlight adjustment of claim 7, wherein the portable display device comprises a storage unit for storing a brightness value data corresponding to the backlight brightness setting information,
and (b) comprises,
(b1) reading out from the storage unit the brightness value data corresponding to the transmitted backlight brightness setting information; and
(b2) adjusting the brightness of the backlight lamp based on the read-out brightness value data.

9. The backlight adjustment method of claim 8, wherein the portable display device comprises a controller controlling the read-out of the brightness value data and adjustment of the brightness of the backlight lamp, and (a) is performed by designating the controller with a slave address of a transfer data of the I²C bus, and (b1) and (b2) are performed under the control of the controller based on the transmitted backlight brightness setting information.
